(19) United States
(12) Patent Application Publication
(10) Pub. No.: US 2013/0068831 A1
(43) Pub. Date: Mar. 21, 2013

(54) MANAGING INFORMATION USING MACHINE-READABLE CODES

(71) Applicants: Ronald Steven Cok, Rochester, NY (US); Thomas Joseph Murray, Cochocton, NY (US)

(72) Inventors: Ronald Steven Cok, Rochester, NY (US); Thomas Joseph Murray, Cochocton, NY (US)

(21) Appl. No.: 13/235,812

(22) Filed: Sep. 19, 2011

(51) Int. Cl. G06F 17/30

(52) U.S. Cl. 235/375

(57) ABSTRACT

A method for managing information includes providing a code referencing an unassigned uniform resource identifier (URI) to a plurality of users; using a processor to receive a URI access request for the unassigned URI and information from a user; after receiving the URI, forming a storage location at the URI and storing the received information at the formed URI storage location; receiving one or more URI access requests including the URI and additional information from each of one or more users; and storing the received additional information at the formed URI storage location without removing stored information at the formed URI storage location.

### CROSS REFERENCE TO RELATED APPLICATION

Reference is made to commonly-assigned, U.S. patent application Ser. No. ______, entitled “System for Managing Information using Machine-Readable Codes” filed concurrently herewith by Ronald S. Cok et al, the disclosure of which is incorporated herein.

### FIELD OF THE INVENTION

The present invention relates to the use of machine-readable codes for managing information and, in particular, to receiving and storing information.

### BACKGROUND OF THE INVENTION

Machine-readable codes have been in use for many years. Such codes are often implemented as optical codes that are read by capturing the reflection of electromagnetic radiation from the code. The ubiquitous one-dimensional barcode is used for product tracking and to automate purchases. For example, one-dimensional barcodes are in widespread use for managing point-of-sale purchase transactions using computer-controlled laser scanners.

More recently, two-dimensional codes, also known as matrix barcodes, such as QR (“Quick Response”) codes, have become popular. Two-dimensional codes can encode a much greater quantity of information than one-dimensional codes. The information encoded in such codes is readily accessed through digital photographs of the codes that are processed by application software found in computers and mobile communication devices such as cell phones having digital signal processing and internet communication access. QR codes are frequently employed in conjunction with product advertising to provide an internet URI website link with information about the product advertised.

Optical bar codes are typically intended to be visually observable by humans, so that humans can find the codes and take appropriate action to access encoded information or otherwise use the codes. In contrast, steganographic information is designed to be hidden within an image. The present invention addresses optical codes that are intended to be observable to humans and does not address steganographic codes. Referring to FIG. 12, a matrix barcode of the prior art is illustrated with dark and light elements forming black modules on a white background. As used herein, the term matrix barcode is used synonymously with two-dimensional optical code. A QR code is an example of a matrix barcode. Such codes are machine-readable and are input by a machine (such as a scanner or digital imager), analyzed with image processing equipment and software, and the information encoded in the code decoded, extracted, and used.

The formation, printing, scanning, and decoding of one- and two-dimensional bar codes is known in the art. For example, U.S. Pat. No. 7,273,175 describes a method, apparatus and a storage medium for locating QR codes. An image processing apparatus including an optical reader and image processing hardware is discussed in U.S. Pat. No. 7,835,037. U.S. Pat. No. 7,841,531 discloses a camera operating system and matrix decoding device. U.S. Patent Application Publication 20090078772 describes techniques for decoding images of barcodes. U.S. Pat. No. 6,229,964 addresses an icon reader that reads picture identification data from a data icon on an image print. U.S. Pat. No. 7,123,782 describes using a code printed in association with a printed image to identify an electronic repository for a digital version of the printed image.

Codes on an image print can include a reference to remotely-stored information. A code reader can scan the code, decode the reference, and retrieve the information. For example, U.S. Pat. No. 6,199,048 describes a system and method for using identification codes found on ordinary articles of commerce to access remote computers on a network. U.S. Patent Application Publication 2004/0096123 discloses a method and system for locating and accessing digitally stored images including a hard copy print, method and system for producing the hard copy print.

Internet-based storage facilities use pre-allocated universal resource locators (“URLs) or universal resource indicators (“URIs”) to specify the location of stored information, such as text, images, audio files, and documents as well as interactive websites. Users can upload information, such as images, to the storage sites associated with the URLs, for example in a database, usually by interacting with the website through a web browser. Information can also be emailed to a service provider and stored in an internet-accessible storage device. In some cases, a designated URL can reference a second URL to redirect a user to another internet location. For example, www.qrjumps.com provides such services associated with a QR code.

It is useful to communicate with a large group of potential respondents that can provide information for remote storage over the internet. However, it is costly and inefficient to provide storage facilities without a clear indication of information type and quantity. Furthermore, communication addresses for the potential respondents are not always known, particularly for self-selected groups whose members wish to use a storage service.

There remains a need, therefore, for a system and method for efficiently communicating with an unspecified group, receiving information from members of the group, and interactively storing information for the members of the group.

### SUMMARY OF THE INVENTION

In accordance with the present invention, there is provided a method for managing information, comprising the steps of:

providing a code referencing an unassigned uniform resource identifier (URI) to a plurality of users;

using a processor to receive a URI access request for the unassigned URI and information from a user;

after receiving the URI, forming a storage location at the URI and storing the received information at the formed URI storage location;

receiving one or more URI access requests including the URI and additional information from each of one or more users; and

storing the received additional information at the formed URI storage location without removing stored information at the formed URI storage location.

The present invention provides a method for efficiently communicating with an unspecified group, receiving information from members of the group, and interactively storing information for the members of the group.

These, and other, attributes of the present invention will be better appreciated and understood when considered in conjunction with the following description and the accompanying drawings. It should be understood, however, that the following description, although indicating embodiments of the present invention and numerous specific details thereof, is given by way of illustration and not of limitation. Many of the elements described as related to a particular embodiment can be used together with, and possibly interchanged with, elements of other described embodiments. The figures below are not intended to be drawn to any precise scale with respect to relative size, angular relationship, or relative position or to any combinational relationship with respect to interchangeability, substitution, or representation of an actual implementation.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIG. 1 is a flow diagram of a method according to an embodiment of the present invention;

FIG. 2 is a flow diagram of the method according to another embodiment of the present invention;

FIG. 3 is a flow diagram the method according to yet another embodiment of the present invention;

FIGS. 4A and 4B are flow diagrams useful for various embodiments of the present invention;

FIG. 5 is a schematic of a user photographing a machine-readable code according to a method of the present invention;

FIG. 6 is a schematic of a system useful with the present invention;

FIG. 7 is a schematic of a mobile communication device useful with the present invention;

FIG. 8 is a perspective of mobile communication devices useful with the present invention;

FIG. 9 is a schematic of a simple system useful in various embodiments of the present invention;

FIG. 10 is an illustration of an embodiment of a computer system useful in various embodiments of the present invention;

FIG. 11 is an illustration of an embodiment of a desktop computer, work station, or kiosk that can be used in a system of FIG. 10; and

FIG. 12 is a prior-art QR code useful in understanding the present invention.

### DETAILED DESCRIPTION OF THE INVENTION

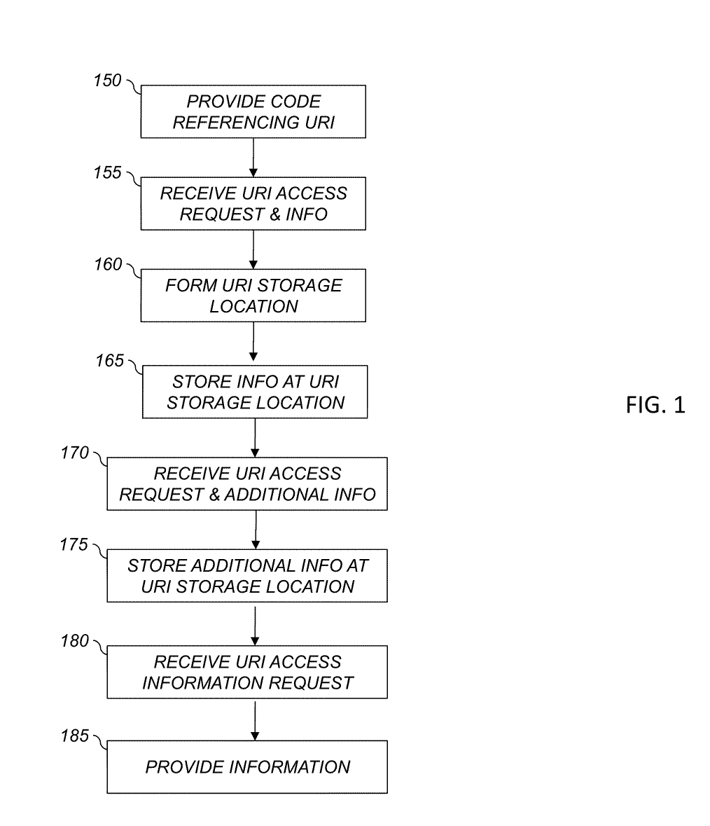

Referring to FIG. 1, according to an embodiment of the present invention, a method of managing information comprises the steps of providing a code referencing an unassigned uniform resource identifier (URI) to a plurality of users in step 150 and receiving a URI access request for the unassigned URI and information from a user in step 155. After receiving the URI, a storage location at the URI is formed in step 160 and the received information stored at the formed URI storage location in step 165. One or more URI access requests including the URI and additional information are received from each of one or more users in step 170 and the received additional information is stored at the formed URI storage location without removing stored information at the formed URI storage location in step 175. In a further embodiment of the present invention, a URI access request for information is received in step 180 and the information provided in step 185, for example to one or more of the users.

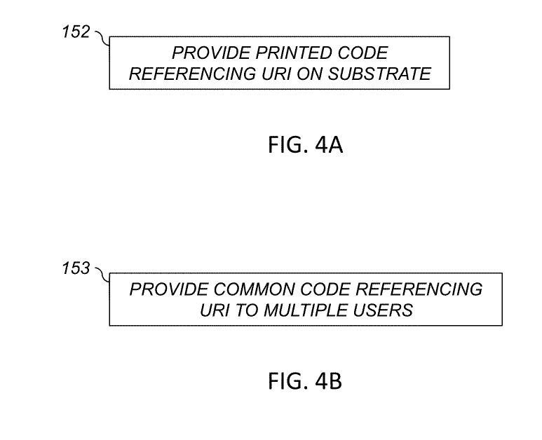

In various embodiments of the present invention, the code is a machine-readable code, for example an optical code, a one-dimensional barcode, a two-dimensional bar code, a matrix code, or a QR (“Quick Response”) code. A variety of such codes are known in the art. The code can be provided on a variety of substrates (FIG. 4A step 152), for example printed on sheets of paper, cards, or electronically presented on a display.

The received information can be audio, image, or text information, or any combination of audio, image, or text information, or can be other types of digital information that can be stored in a retrieval system. The received information can be references to other information, information stored in other locations, or the location of other stored information. The received information can be stored in a variety of ways, for example as a single file or multiple files, stored in a database including one or more files, or stored within a folder in a logical file-storage hierarchy one or more files. Such storage methods are known in the computer science arts.

In a first embodiment, the provided code references an unassigned internet-accessible universal resource identifier (URI). An unassigned universal resource identifier is a URI that does not resolve to pre-existing user-specific content. For example the code can directly or indirectly reference a storage location that does not exist but is associated with the service provider. The service provider maintains a network-accessible storage device but without user-specific storage locations formed in the network-accessible storage device. For example, a URI might reference “http://serviceprovider.com/storagelocation” where the “serviceprovider.com” is an existing domain and web server, but the “storagelocation” specifier is initially not resolvable to user-specific content. According to the prior art, such an unassigned URI request could return a user-specific web page such as a 404 error page or a page inviting the user to establish “storagelocation” and upload user-specific content to it. Instead, according to an embodiment of the present invention, after receiving the URI, a storage location is formed at the URI and the received information stored at the formed URI storage location.

Alternate embodiments of the URI might include http://storagelocation.serviceprovider.com, where “storagelocation: is an initially undefined subdomain of serviceprovider.com, or http://serviceprovider.com/?q=storagelocation, where storagelocation is an initially undefined parameter value passed to the serviceprovider.com web server.

A user of services provided by the service provider can photograph or scan the code, for example employing a smart-phone with an integrated digital camera and analyze the code photograph to extract the encoded URI using software integrated into the smart-phone. Such smart-phone devices, digital cameras, and software are known in the art. In step 160, additional software is employed to transfer information stored in the smart-phone to the service provider at an address that does exist and is represented by a portion of the URI. Software operative on the service provider's server at the address receives the transferred information, creates the storage location and stores the received information at the encoded location in step 165. The same user or other users can then make subsequent requests for storing information (step 170) or for retrieving information (step 180) that are fulfilled in steps 175 or 185, respectively.

The present invention usefully provides a way to support a group of users that collaborate on providing information for a common purpose when the number of users in the group is unknown. In an extreme case, no users at all participate in an activity. In this case, it is inefficient for a service provider to provide storage services. In another case, the activity is unknown; again, it is inefficient for a service provider to provide resources for an unknown purpose. In the case wherein a first user decides to take advantage of the service provider's services, he or she can upload information related to a desired activity to the service provider. The service provider then provides the needed resources to support the activity and receives further information from other users. The information can then be made available to any user. Storage and access requests are made with the information encoded in the code to indicate the storage location.

As a specific example, consider a celebration-services provider (e.g. a wedding, graduation, or reunion) that provides digital information services to celebrating groups, for example providing photobooks and image slide shows that can include digital still image information digital video image information, audio information, or text information, or any combination of such information types. The code can be provided to any and all groups considering a celebratory event without initial concern for service usage or storage requirements. If no groups take advantage of the services, the service provider experiences no costs, other than the provision of the codes. However, if a group member decides to take advantage of the services, services are allocated as needed, providing a very efficient means of meeting the needs of the group.

From a user's perspective, he or she is presented with a service, such as an ability to contribute to a group wedding gift such as a photobook. Such a service can be provided, for example, through a website or through an application operable on a cellular telephone with digital camera, digital communications with the internet, and software application capability accessed through the code. In an embodiment, a software application is provided that records audio information, forms a digital image of the code, decodes the encoded code information to provide the unassigned URI reference, and transmits the recorded audio information to the unassigned URI. The services can be presented at the celebration or perhaps in association with a celebration invitation. After deciding to participate, the user can download an application from a website to enable interaction with the service provider.

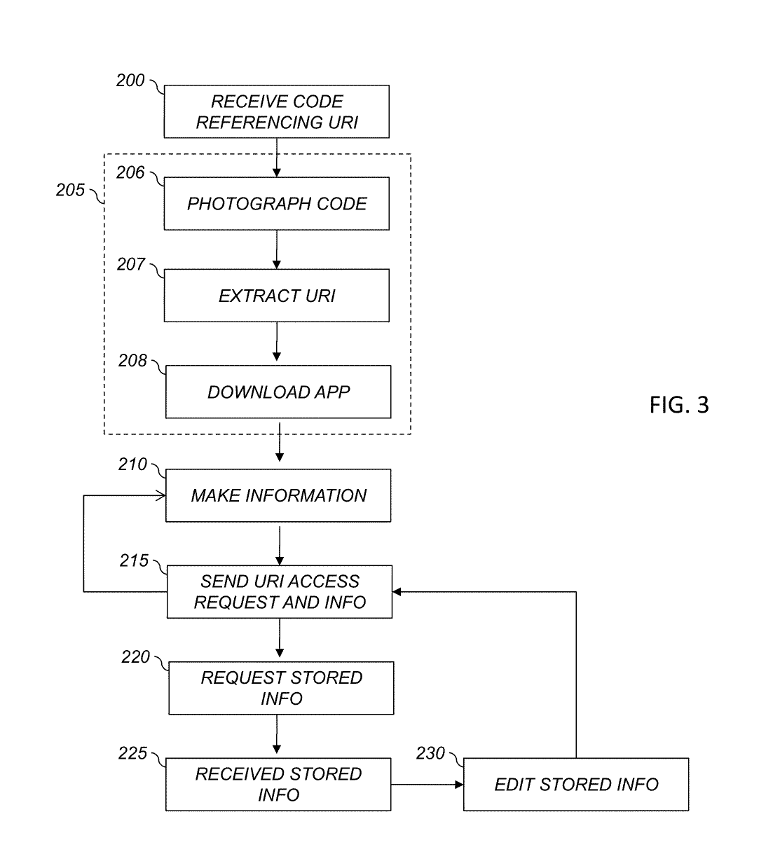

In one embodiment, referring to FIG. 3, one of many users receives a code referencing the unassigned URI (step 200). Information is obtained relevant to obtaining the code (step 205). For example, an existing software tool can be used to photograph the code (step 206) and the URI extracted from the photograph (step 207). The URI can be access and a software application can be downloaded (step 208). The user then makes information (e.g. takes a photograph or video, records audio, or creates a text message) in step 210, uploads the information (in association with the code URI) in step 215 that is received by the service provider who then makes the needed storage location and stores the uploaded information. Other collaborating participants similarly contribute other information, such as video clips, audio recording, text messages, and the like, thus repeating steps 210 and 215. The stored information (in one embodiment including a product incorporating the uploaded information) is requested (step 220) and received (step 225) from the service provider. Alternatively, the service provider provides information without a request. Thus, the product can be advertised to the participants or ordered by the participants at the celebration.

In a further embodiment of the present invention, participants can modify their information after it has been uploaded by requesting the information (step 225) and editing the requested information (step 230). Additional software utilities can enable users to retrieve, replace, edit, or remove the stored information in response to a request. To efficiently and easily enable interaction with the storage facility, a network-accessible user interface to the formed URI storage location for interacting with the information stored at the formed URI storage location is provided.

Additional information can be provided to enhance the user experience or provided services, including user information. The user information can be associated with the stored information. For example, details of the user's relationship to a guest of honor at the celebration or an email address for communicating information regarding a digital information product is transmitted by the user and received by the service provider.

To further facilitate interactions between user groups and the service provider, an identifier can be provided with uploaded information to identify the stored information. The identifier can identify the event and provide a way to associate information uploaded from multiple users into a common event. Useful identifiers can include an event name, a cellular telephone number, an email address, a user-selected identifier, a portion of a URI, or a random number. The identifier can be provided by the service provider, for example in response to an initial user interaction, and subsequently communicated to other users in the group. Alternatively, one or more users can select an identifier that is subsequently communicated to other users in the group. In this way, a service provider can support multiple groups with different and independent digital information at the same time, for example by forming different storage locations, one for each identifier. The identifier is thus used to associate received information into groups and to identify the groups. Furthermore, participants can interact securely with the uploaded information by providing the URI and identifying information to the software utility or service provider.

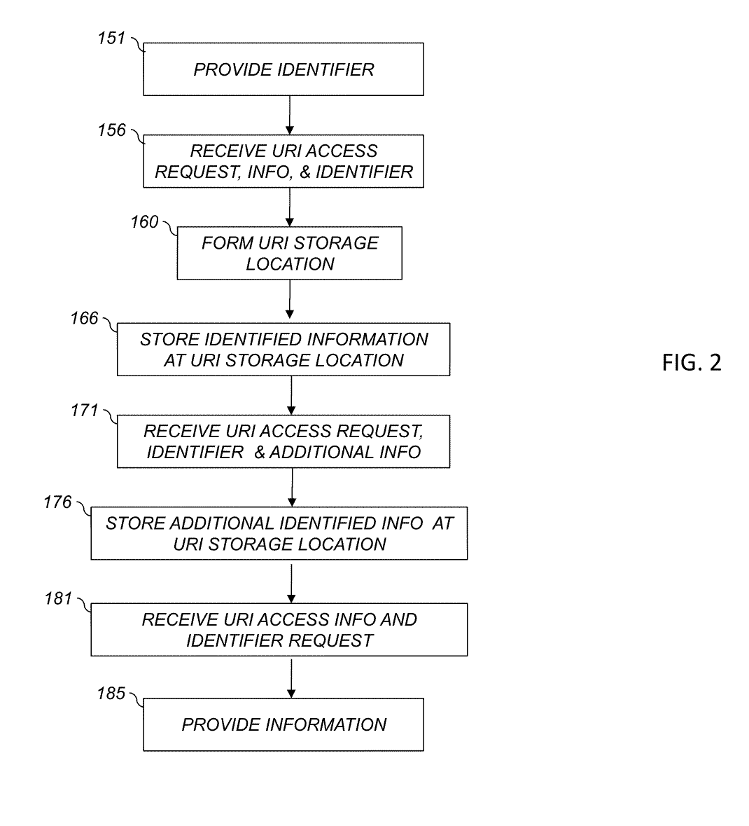

Referring to FIG. 2, an identifier is provided in step 151, for example by receiving the identifier from a user or by selecting an identifier. The identifier can be provided in response to a URI access corresponding to the provided code (step 150 of FIG. 1). A URI access request including information and the identifier is received in step 156, a URI storage location formed in step 160, and the information stored in association with the identifier in step 166. A subsequent URI access with the identifier and additional information is received in step 171 and stored in step 176. In step 181, a URI access request for identified information is received and provided (step 185).

In one embodiment of the present invention, all of the information uploaded from a group is stored in a common storage location and all users in the group can have access to all of the information. In another embodiment, the information is securely associated with individuals and access to others is restricted. Thus, a user might be able to edit his or her contributed information as a consequence of a request to retrieve the contributed information while others can only read the information.

In a further embodiment of the present invention, a plurality of different codes referencing a corresponding plurality of different unassigned uniform resource identifiers (URIs) to a plurality of users is provided (FIG. 4B step 153). A plurality of different URI access requests for the different unassigned URIs and different information is received from a plurality of users. After receiving the URI access requests, storage locations are formed at the different URIs and the different received information stored at corresponding formed URI storage locations. One or more URI access requests including the URIs and additional information are received from each of one or more users and the received additional information stored at the formed URI storage locations without removing stored information at the formed URI storage location. In this way, a single user provider can simultaneously support a plurality of groups. Rather than requiring, for example, that each group employ a different identifier to distinguish it from other groups, a different code is supplied to different groups. For example, a celebration coordinator could register an event with a service provider and receive a code that can be provided in common to a group of users. Each registration can result in a different code. Thus every member of a group receives a common code and the code is different for each different group. The codes can be provided on a plurality of different substrates, for example each group could receive cards with printed codes. All of the cards for a first group would have a first code printed on them while all of the cards for a second, different group would have a second code different from the first code printed. Codes could also be distributed electronically and presented, for example, on the displays of cell phones such as digital-communication-network-enabled smart-phones.

In one embodiment of the present invention, a digital image of the code is transmitted to the service provider, which then extracts the desired URI. This makes it unnecessary for a user to decode the code. Alternatively, software operative on a user's computing device extracts the URI reference from the code.

In an embodiment of the present invention, an apparatus includes a substrate and a machine-readable optical code formed on the substrate. The machine-readable optical code encodes a reference to an unassigned computer network-accessible electronic storage location.

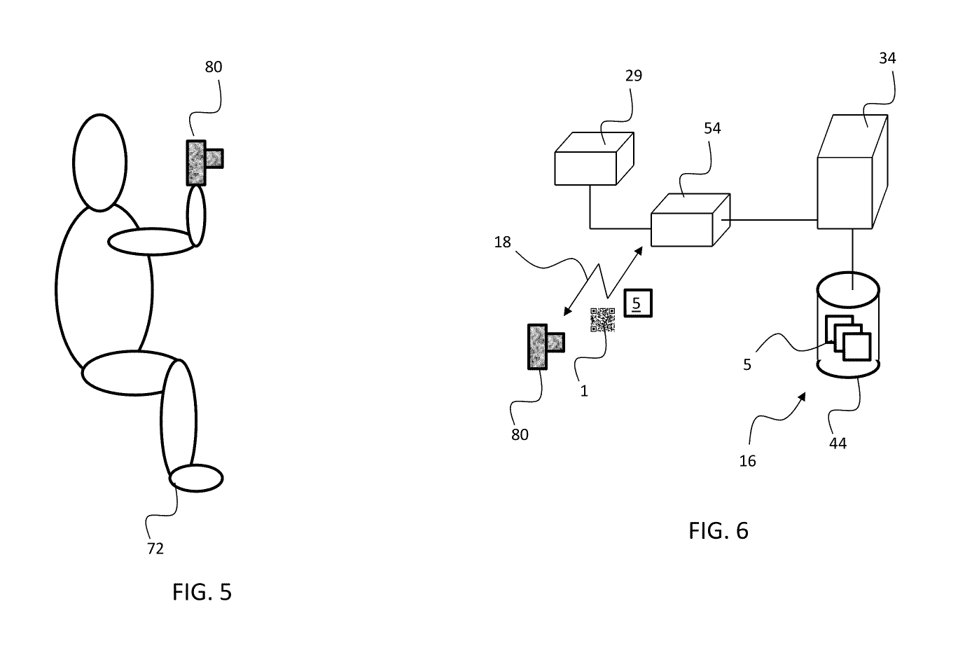

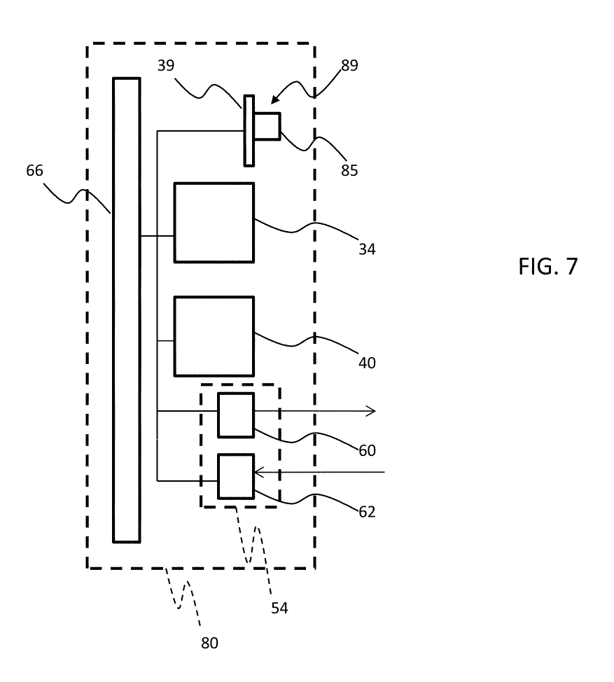

The capture, transmission, and storage of digital information such as images, videos, audio, and text are well known in the art. For example, as shown in FIGS. 5 and 11, a user 72 can use a mobile communication system 80 that incorporates a digital camera 89 to photograph machine-readable codes and other digital images. The mobile communication system 80 can be located at a suitable distance from the machine-readable code 1 (as technically enabled by the digital camera 89 in the mobile communication system 80, for example using the optical lens system 85 shown in FIG. 7) for photographing the machine-readable code 1. Suitable mobile communication devices 80 are known in the art.

Likewise, as shown in FIG. 6, systems that communicate with mobile communication devices 80 through wireless (e.g. WiFi, Bluetooth) or wired (e.g. wired Ethernet, USB) communication channels 18 are known. A variety of systems can be used to implement the various methods of the present invention. Referring to FIG. 6, in one embodiment, such a system can include a communication system 54, a processor 34 and an electronic storage and retrieval system 16 (e.g. a disk drive 44) communicatively interconnected. Such computer system components are well known in the art as are software applications, utilities, and programs that execute on the processor 34. The processor 34 can be a single processor or can include multiple processors or distributed processors. All of the processing tasks can be done on a single processor 34 or can be done using multiple, different processors 34. The system for forming storage locations includes an electronic storage and retrieval system 16, the processor 34 connected to one or more remote client computer(s) (e.g. mobile communication system 80) through a communication channel 18, the processor 34 connected and having access to the electronic storage and retrieval system 16. The communication channel 18 can be a network and can interact with the processor 34 through the communication system 54.

The user 72 can photograph scenes and transmit the captured scenes through the communication channel 18 to the communication system 54 to be stored by the processor 34 on the disk drive 44 in the electronic storage and retrieval system 16 as a digital image 5.

The processor 34 can include a way to transmit and receive information from and to a remote client computer (e.g. mobile communication system 80), receive digital information 5 from the remote client computer mobile communication system 80 through the communication channel 18 and store the received digital information 5 in the electronic storage and retrieval system 16. The processor 34 also includes a way to receive references or receive photographs of machine-readable codes 1 and extract the references from the received photographs of the machine-readable codes 1 and form URI storage locations. Computer system components for storing, communicating, retrieving, and processing digital images are known in the art and discussed in greater detail with respect to FIGS. 7-9 below. The formation of storage locations for digital information is also known in the computer and digital communication network arts.

Referring in more detail to the mobile communication system 80, as shown in FIG. 7, a mobile communication system 80 useful in various embodiments of the present invention can include a display 66 connected to a processor 34, a memory 40, communication system 54 including a transmitter 60 and a receiver 62, and an image sensor 39 with the optical lens system 85 forming the digital camera 89. The processor 34 can execute software stored in the memory 40 to acquire digital images 5 with the digital camera 89, display the digital images 5 on the display 66, store the digital images 5 in the memory 40, or transmit the digital images 5. The processor 34 can also receive software from a network storage device and execute the software. The digital image 5 can be a scene or an image of a printed or displayed thumbnail image or of a machine-readable code 1. Such image capture, display, and storage software is known. In one embodiment, the mobile communication system 80 can include software stored in the memory 40 executed by the processor 34 to extract encoded references from photographs of machine-readable codes 1. Software for forming machine-readable codes 1 and for extracting references from machine-readable codes 1 is known.

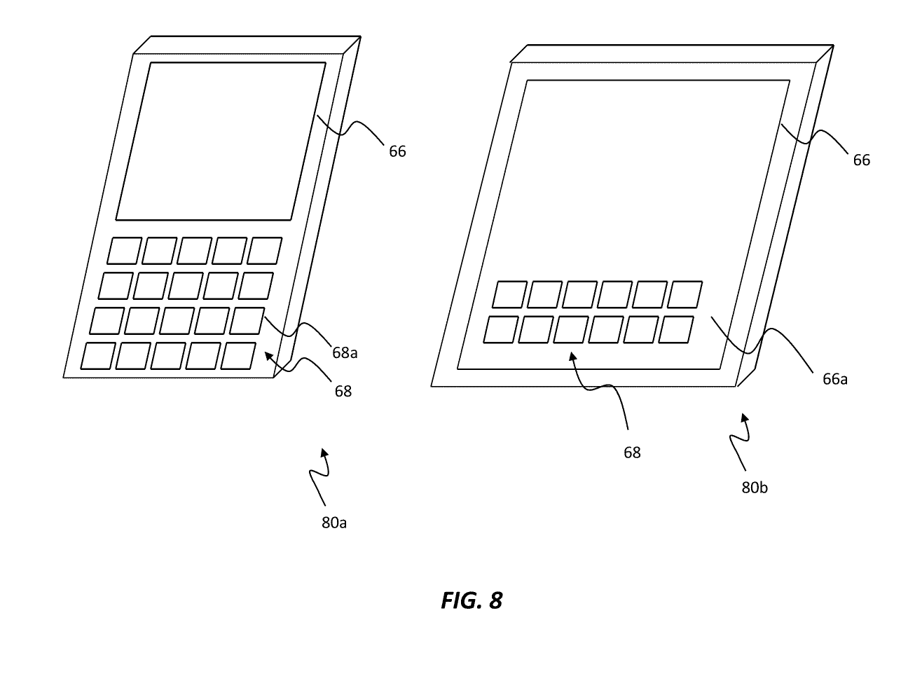

FIG. 8 is a perspective of a mobile communication system 80a and 80b that include the display 66 together with a local input mechanism 68 such as a local keyboard 68a (FIG. 8). Mobile communication system 80b includes a display 66a that incorporates a touch-screen providing local input 68. Both mobile communication systems 80a that include keyboards 68a or mobile communication systems 80b that include displays with touch-screens 66a are known in the art. As shown in FIG. 7, a mobile communication system 80 can communicate through a communication channel 18, either through wireless or wired networks, or through a point-to-point communication device, with a remote display 67 to display images, for example, on a larger display than is present on the mobile communication device itself.

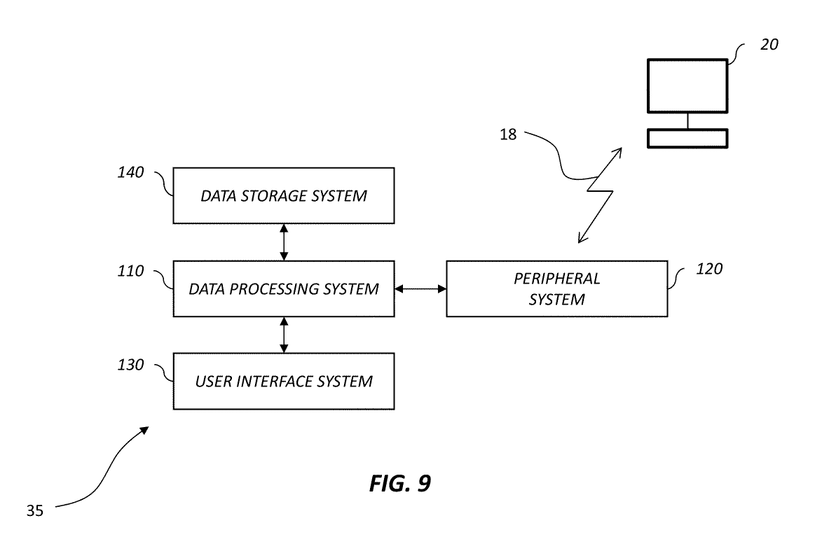

FIG. 9 is a high-level diagram showing the components of a remote electronic computer system 35 useful for various embodiments of the present invention. The remote electronic computer system 35 includes a data processing system 110, a peripheral system 120, a user interface system 130, and a data storage system 140. The peripheral system 120, the user interface system 130 and the data storage system 140 are communicatively connected to the data processing system 110.

The data processing system 110 includes one or more data processing devices that implement the processes of the various embodiments of the present invention, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, a digital picture frame, cellular phone, a smart phone or any other device for processing data, managing data, communicating data, or handling data, whether implemented with electrical, magnetic, optical, biological components, or otherwise.

The data storage system 140 includes one or more processor-accessible memories configured to store information, including the information needed to execute the processes of the various embodiments of the present invention, including the example processes described herein. The data storage system 140 can be a distributed processor-accessible memory system including multiple processor-accessible memories communicatively connected to the data processing system 110 via a plurality of computers or devices. On the other hand, the data storage system 140 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, caches, floppy disks, hard disks, Compact Discs, DVDs, flash memories, ROMs, and RAMs.

The phrase “communicatively connected” is intended to include any type of connection, whether wired or wireless, between devices, data processors, or programs in which data is communicated. The phrase “communicatively connected” is intended to include a connection between devices or programs within a single data processor, a connection between devices or programs located in different data processors, and a connection between devices not located in data processors at all. In this regard, although the data storage system 140 is shown separately from the data processing system 110, one skilled in the art will appreciate that the data storage system 140 can be stored completely or partially within the data processing system 110. Further in this regard, although the peripheral system 120 and the user interface system 130 are shown separately from the data processing system 110, one skilled in the art will appreciate that one or both of such systems can be stored completely or partially within the data processing system 110.

The peripheral system 120 can include one or more devices configured to provide digital content records to the data processing system 110. For example, the peripheral system 120 can include digital still cameras, digital video cameras, cellular phones, smart phones, or other data processors. The data processing system 110, upon receipt of digital content records from a device in the peripheral system 120, can store such digital content records in the data storage system 140. The peripheral system 120 can be connected through a communication channel 18 (e.g. the internet or cell-phone networks) to other electronic computer systems 20.

The user interface system 130 can include a mouse, a keyboard, another computer, or any device or combination of devices from which data is input to the data processing system 110. In this regard, although the peripheral system 120 is shown separately from the user interface system 130, the peripheral system 120 can be included as part of the user interface system 130.

The user interface system 130 also can include a display device, a processor-accessible memory, or any device or combination of devices to which data is output by the data processing system 110. In this regard, if the user interface system 130 includes a processor-accessible memory, such memory can be part of the data storage system 140 even though the user interface system 130 and the data storage system 140 are shown separately in FIG. 9.

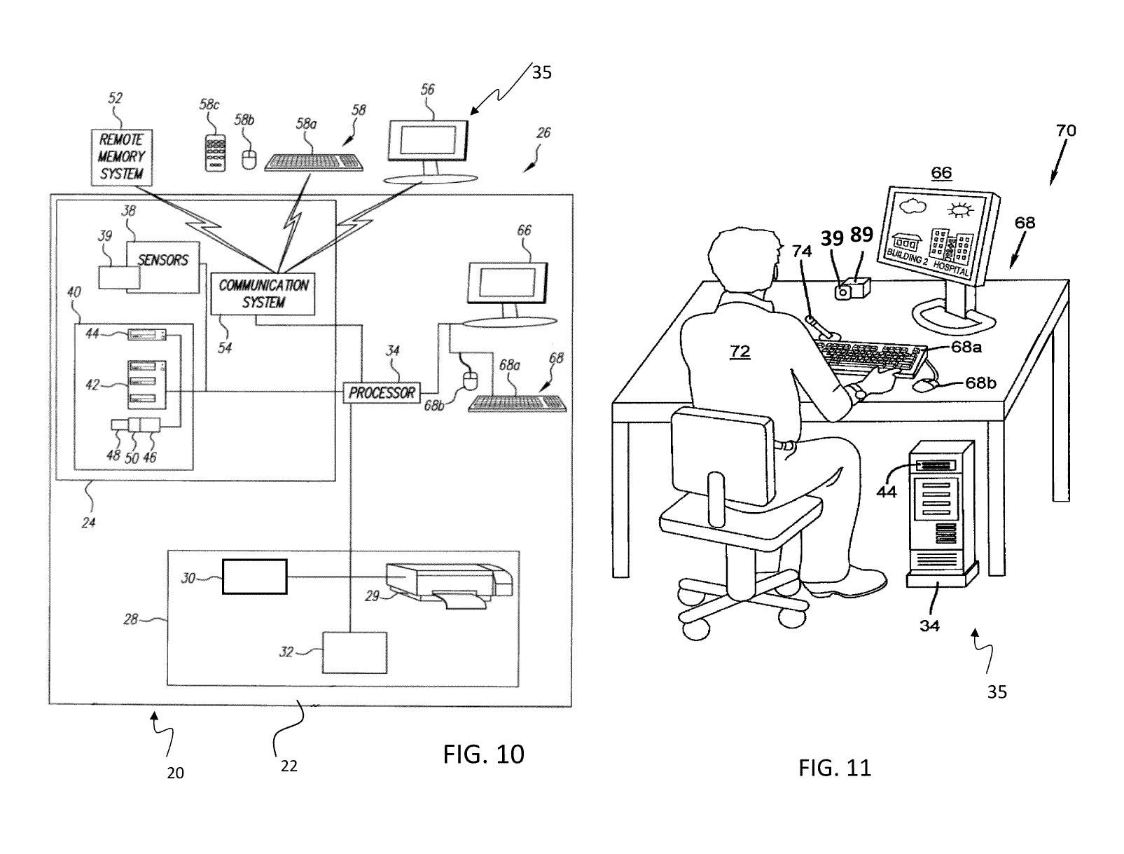

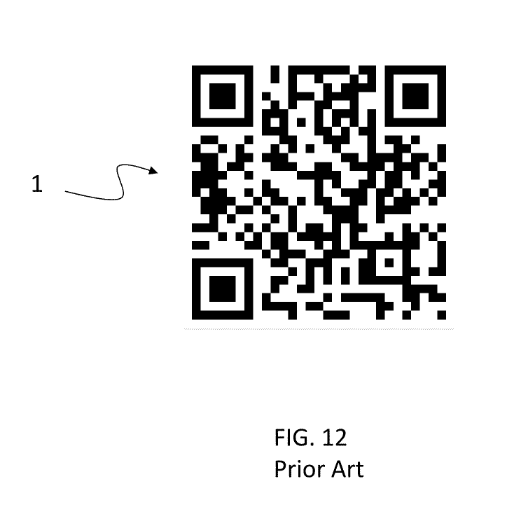

As shown in FIG. 10 in more detail, a computer system according to various embodiments of the present invention includes the electronic computer system 20, for example a computer server, connected to a remote electronic computer system 35, for example a remote client computer such as a mobile communication device 80 (FIG. 6), through a communication channel 18 (FIG. 6), the electronic computer system 20 including memory 40 for storing one or more digital image files communicated through the computer network to the remote electronic computer system 35, the remote electronic computer system 35 having the local display 66 for displaying the digital images 5 in a graphic user interface.

In the embodiment of FIG. 10, the electronic computer system 20 includes the source of content data files 24, the user input system 26 and the output system 28 connected to the processor 34. The source of content data files 24, user-input system 26 or output system 28, and processor 34 are positioned within the housing 22 as illustrated. In other embodiments, circuits and systems of the source of content data files 24, user input system 26 or output system 28 are positioned in whole or in part outside of housing 22.

The source of content data files 24 can include any form of electronic or other circuit or system that can supply digital data to processor 34 from which processor 34 can derive images for use in forming a digital image file. In this regard, the content data files 24 can include, for example and without limitation, still images, image sequences, video graphics, and computer-generated images. Source of content data files 24 can optionally capture images to create content data for use in content data files by use of capture devices located at, or connected to, electronic computer system 20 or can obtain content data files 24 that have been prepared by or using other devices such as the remote electronic computer system 35. In the embodiment of FIG. 10, source of content data files 24 includes sensors 38, the memory 40 and the communication system 54.

Sensors 38 are optional and can include light sensors, biometric sensors and other sensors known in the art that can be used to detect conditions in the environment of electronic computer system 20 and to convert this information into a form used by processor 34 of electronic computer system 20. Sensors 38 can also include one or more image sensors 39 that are adapted to capture still or video images. Sensors 38 can also include biometric or other sensors for measuring involuntary physical and mental reactions such sensors including, but not limited to, voice inflection, body movement, eye movement, pupil dilation, body temperature, and p4000 wave sensors.

Memory 40 can include conventional memory devices including solid-state, magnetic, optical or other data-storage devices. Memory 40 can be fixed within electronic computer system 20 or it can be removable. In the embodiment of FIG. 10, electronic computer system 20 is shown having a hard drive 42, the disk drive 44 for a removable disk such as an optical, magnetic or other disk memory (not shown) and the memory card slot 46 that holds the removable memory 48 such as a removable memory card and has the removable memory interface 50 for communicating with removable memory 48. Data including, but not limited to, control programs, digital images and metadata can also be stored in the remote memory system 52 such as the remote electronic computer system 35, a personal computer, computer network or other digital system. Remote memory system 52 can also include solid-state, magnetic, optical or other data-storage devices.

In the embodiment shown in FIG. 10, electronic computer system 20 has the communication system 54 that in this embodiment is used to communicate with remote electronic computer systems 35 for example including an optional remote memory system 52, an optional remote display 56, or optional remote input 58 (also referred to herein as “remote input 58”). The optional remote memory system 52, optional remote display 56, and optional remote input 58 can all be part of the remote electronic computer system 35 having the remote input 58 with remote input controls, and that can communicate with communication system 54 wirelessly as illustrated or can communicate in a wired fashion. In an alternative embodiment, a local input station including either or both of the local display 66 and local input controls 68 (also referred to herein as “local user input 68”) are connected to communication system 54 using a wired or wireless connection.

Communication system 54 can include for example, one or more optical, radio frequency or other transducer circuits or other systems that convert image and other data into a form that is conveyed to a remote device such as the remote memory system 52 or the remote display 56 using an optical signal, radio frequency signal or other form of signal. Communication system 54 can also be used to receive a digital image and other data from a host or server computer or network (not shown), the remote memory system 52 or the remote input 58. Communication system 54 provides processor 34 with information and instructions from signals received thereby. Typically, communication system 54 will be adapted to communicate with the remote memory system 52 by way of a communication network such as a conventional telecommunication or data transfer network such as the internet, a cellular, peer-to-peer or other form of mobile telecommunication network, a local communication network such as wired or wireless local area network or any other conventional wired or wireless data transfer system. In one useful embodiment, the electronic computer system 20 can provide web access services to remote electronic computer systems 35 that access the electronic computer system 20 through a web browser. Alternatively, the remote electronic computer system 35 can provide web services to electronic computer system 20 depending on the configurations of the systems.

User input system 26 provides a way for a user 72 (FIG. 11) of electronic computer system 20 to provide instructions to processor 34. This permits the user 72 to make a designation of content data files 24 to be used in generating a digital image file and to select an output form for an output product or print. User input system 26 can also be used for a variety of other purposes including, but not limited to, permitting the user 72 to arrange, organize and edit content data files 24 to be incorporated into the image-enhanced output product, to provide information about the user or audience, to provide annotation data such as voice and text data, to identify characters in the content data files 24, and to perform such other interactions with electronic computer system 20 as are described herein.

In this regard user input system 26 can include any form of transducer or other device capable of receiving an input from the user 72 and converting this input into a form used by processor 34. For example, user input system 26 can include a touch screen input, a touch pad input, a 4-way switch, a 6-way switch, an 8-way switch, a stylus system, a trackball system, a joystick system, a voice recognition system, a gesture recognition system a keyboard, a remote control or other such systems. In the embodiment shown in FIG. 10, user input system 26 includes the optional remote input 58 including a remote keyboard 58a, a remote mouse 58b, and a remote control 58c and the local user input 68 including a local keyboard 68a and a local mouse 68b.

Remote input 58 can take a variety of forms, including, but not limited to, the remote keyboard 58a, remote mouse 58b or remote control handheld device 58c illustrated in FIG. 10. Similarly, local user input 68 can take a variety of forms. In the embodiment of FIG. 10, local display 66 and local user input 68 are shown directly connected to processor 34.

As is illustrated in FIG. 11 local user input 68 can take the form of an editing area 70 such as a home computer, an editing studio, or kiosk that can also be the remote electronic computer system 35. In this illustration, the user 72 is seated before a console including local keyboard 68a and mouse 68b and a local display 66 which is capable, for example, of displaying multimedia content, for example in a graphic user interface. As is also illustrated in FIG. 11, editing area 70 can also have sensors 38 including, but not limited to, image sensors 39, audio sensors 74 and other sensors such as multispectral sensors that can monitor user 72 during a production session or provide other information such as images.

Output system 28 (FIG. 10) is used for rendering images, text or other graphical representations in a manner that permits printing image, text, or other graphical representations. In this regard, output system 28 can include any conventional structure or system that is known for printing or recording images on an output device 32 including, but not limited to, a printer 29. Printer 29 can record images on a tangible surface 30 using a variety of known technologies including, but not limited to, conventional four-color offset separation printing or other contact printing, silk screening, dry electrophotography such as is used in the NexPress 2100 printer sold by Eastman Kodak Company, Rochester, N.Y., USA, thermal printing technology, drop-on-demand inkjet technology and continuous inkjet technology. For the purpose of the following discussions, printer 29 will be described as being of a type that generates color images. However, it will be appreciated that this is not needed and that the claimed methods and apparatuses herein can be practiced with the printer 29 that prints monotone images such as black and white, grayscale, or sepia-toned images. As will be readily understood by those skilled in the art, the electronic computer system 20 can be separated from the remote electronic computer system 35 connected to the printer 29.

In certain embodiments, the source of content data files 24, user input system 26 and output system 28 can share components.

Processor 34 operates electronic computer system 20 based upon signals from user input system 26, sensors 38, memory 40 and communication system 54. Processor 34 can include, but is not limited to, a programmable digital computer, a programmable microprocessor, a programmable logic processor, a series of electronic circuits, a series of electronic circuits reduced to the form of an integrated circuit, or a series of discrete components.

In an embodiment of the present invention illustrated in FIGS. 7 and 8, the remote electronic computer system 35 is a mobile communication system 80, for example a cellular telephone, a smart phone, or a wirelessly connected hand-held computer such as a tablet computer. The mobile communication system 80 can include the local display 66 or the user-input system incorporating the local input 68 keyboard 68a. In another embodiment, a local input 68 device is a touch screen. The mobile communication system 80 can communicate with electronic computer system 20 directly, for example through a wireless local area network or a point-to-point wireless connection, or indirectly through a cellular telephony network. The electronic computer system 20 can be a computer server, for example providing browser-based web pages to the remote electronic computer system 35, 80 through the internet.

Any of the electronic computer system 20, remote electronic computer system 35, or the mobile communication system 80 can execute software programs on the internal processor 110, 34. The software programs can interact with the user 72 through a user interface (e.g. local display 66 and local input 68) or with remote computers to accomplish the programmed task. The software programs can execute algorithms to analyze data (e.g. digital image files) or to compute useful values. A computer software program product can include one or more non-transitory, tangible, computer readable storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain embodiments thereof, but it will be understood that variations and modifications can be effected within the spirit and scope of the invention.

### PARTS LIST

1 machine-readable code
5 digital image
16 electronic storage and retrieval system
18 communication channel or network
20 electronic computer system
22 housing
24 source of content data files
26 user input system
28 output system
29 printer
30 tangible surface
32 output device
34 processor
35 remote electronic computer system
38 sensors
39 image sensors
40 memory
42 hard drive
44 disk drive
46 memory card slot
48 removable memory
50 memory interface
52 remote memory system
54 communication system
56 remote display
58 remote input
58a remote keyboard
58b remote mouse
58c remote control
60 transmitter
62 receiver
66 local display
66a local display with touch screen
67 display
68 local input
68a local keyboard
68b local mouse
70 editing area (home computer, editing studio, or kiosk)
72 user
74 audio sensors
80, 80a, 80b mobile communication system
85 optical lens system
89 digital camera
110 data processing system
120 peripheral system
130 user interface system
140 data storage system
150 provide code referencing URI step
151 provide identifier step
152 provide printed code referencing URI on substrate step
153 provide common code referencing URI to multiple users step
155 receive URI request and info step
156 receive URI access request, information and identifier step
160 form URI storage location step
165 store info at URI storage location step
166 store identified information at URI storage location step
170 receive URI access request and additional information step
171 receive URI access request, identifier, and additional information step
175 store additional information at URI storage location step
176 store additional identified information at URI storage location step
180 receive URI access information request step
181 receive URI access request for identified information step
185 provide information step
200 receive code referencing URI step
205 obtain information relevant to code step
206 photograph code step
207 extract URI from photograph step
208 download app step
210 make information step
215 send URI access request and information step
220 request stored information step
225 receive stored information step
230 edit stored information step

1. A method for managing information, comprising:
providing a code referencing an unassigned uniform resource identifier (URI) to a plurality of users;
using a processor to receive a URI access request for the unassigned URI and information from a user;
after receiving the URI, forming a storage location at the URI and storing the received information at the formed URI storage location;
receiving one or more URI access requests including the URI and additional information from each of one or more users; and
storing the received additional information at the formed URI storage location without removing stored information at the formed URI storage location.

2. The method of claim 1, wherein the code is a machine-readable code.

3. The method of claim 2, wherein the machine-readable code is an optical code, a one-dimensional barcode, a two-dimensional bar code, a matrix code, or a QR code.

4. The method of claim 1, wherein the received information is audio, image, or text information.

5. The method of claim 1, further including storing the received information in a single file, storing the received information in a database, or storing the received information in multiple files in a folder of a logical file hierarchy.

6. The method of claim 1, further including retrieving, replacing, editing, or removing the stored information in response to a request.

7. The method of claim 1, further including providing a network-accessible user interface to the formed URI storage location for interacting with the information stored at the formed URI storage location.

8. The method of claim 1, further including receiving user information and associating the user information with the stored information received from a user.

9. The method of claim 1, further including receiving an identifier.

10. The method of claim 9, further including using the identifier to identify the stored information.

11. The method of claim 9, further including retrieving stored information associated with the identifier in response to a request.

12. The method of claim 9, wherein the identifier is an event name, a cellular telephone number, an email address, a user-selected identifier, or a random number.

13. The method of claim 9, further including associating received information into groups and using the identifier to identify the groups.

14. The method of claim 1, further including receiving an identifier that forms a portion of the URI.

15. The method of claim 1, further including forming the code on a plurality of different substrates to a corresponding plurality of users.

16. The method of claim 1, further including providing the information on a substrate.

17. The method of claim 16, further including providing the code on the substrate.

18. The method of claim 1, further including providing a software application that records audio information, forms a digital image of the code, decodes the encoded code information to provide the unassigned URI reference, and transmits the recorded audio information to the unassigned URI.

19. The method of claim 1, further including providing a plurality of different codes referencing a corresponding plurality of different unassigned uniform resource identifier (URI) to a plurality of users; receiving a plurality of different URI access requests for the different unassigned URIs and different information from a plurality of users; after receiving the URI access requests forming storage locations at the different URIs and storing the different received information at corresponding formed URI storage locations; receiving one or more URI access requests including the URIs and additional information from each of one or more users; and storing the received additional information at the formed URI storage locations without removing stored information at the formed URI storage location.

20. The method of claim 19, further including providing the codes on a plurality of different substrates to a corresponding plurality of users.

21. The method of claim 20, further including providing common codes to groups of users.

22. The method of claim 19, further including providing the information on a substrate.

23. The method of claim 20, further including providing the code on the substrate.

24. A method for managing information, comprising the sequential steps of:
receiving a code referencing an unassigned uniform resource identifier (URI) to a plurality of users;
obtaining information relevant to the code;
using a processor to send a URI access request for the unassigned URI and information to a server computer to store the information; and
retrieving stored information from the server computer.

25. The method of claim 24, further including acquiring a digital image of the code and extracting the reference from the code.
